(19) United States
(12) Patent Application Publication
(10) Pub. No.: US 2021/0384936 A1
(43) Pub. Date: Dec. 9, 2021

(54) Cellphone Case With Integrated Game Apparatus

(71) Applicants: Vickie Maughan, Timberville, VA (US); Blaine Maughan, Timberville, VA (US)

(72) Inventors: Vickie Maughan, Timberville, VA (US); Blaine Maughan, Timberville, VA (US)

(21) Appl. No.: 16/891,502

(22) Filed: Jun. 3, 2020

(51) Int. Cl. H04B 1/3888; A45C 11/00; A63F 7/00; A63F 7/04

(52) U.S. Cl. CPC H04B 1/3888; A45C 11/00; A63F 7/0088; A63F 2007/0094; A63F 7/044; A45C 2011/002; A63F 7/041

(57) ABSTRACT

A cellphone case with integrated game apparatus for providing entertainment and anxiety relief includes a case body having a case front side, a case back side, a case left side, a case right side, a case top side, a case bottom side, a case inner face, and a case outer face. The case body secures a cellphone. A game enclosure is coupled to the case body. The game enclosure has an enclosure back side coupled to the case outer face on the case back side and a transparent enclosure front side coupled to the enclosure back side and defining an enclosure inside. A game is coupled within the game enclosure and comprises at least one movable game piece within the enclosure inside.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to cellphone case devices and more particularly pertains to a new cellphone case device for providing entertainment and anxiety relief.

### (2) Description of Related Art Including Information Disclosed Under 37 CFR 1.97 and 1.98

The prior art relates to cellphone case devices with integrated physical features.

Some existing devices incorporate tactile fidget mechanisms such as spinners and switches. These case devices, however, lack an integrated game or puzzle with an objective encased in a transparent cover.

### BRIEF SUMMARY OF THE INVENTION

An embodiment of the disclosure meets the needs presented above by generally comprising a case body having a case front side, a case back side, a case left side, a case right side, a case top side, a case bottom side, a case inner face, and a case outer face. The case body is configured to secure a cellphone. A game enclosure is coupled to the case body. The game enclosure has an enclosure back side coupled to the case outer face on the case back side and a transparent enclosure front side coupled to the enclosure back side and defining an enclosure inside. A game is coupled within the game enclosure and comprises at least one movable game piece within the enclosure inside.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a cellphone case with integrated game apparatus according to an embodiment of the disclosure.

FIG. 2 is a rear elevation view of an embodiment of the disclosure.

FIG. 3 is a front elevation view of an embodiment of the disclosure.

FIG. 4 is a side elevation view of an embodiment of the disclosure.

FIG. 5 is an isometric view of an embodiment of the disclosure.

FIG. 6 is a rear elevation view of an embodiment of the disclosure.

### DETAILED DESCRIPTION OF THE INVENTION

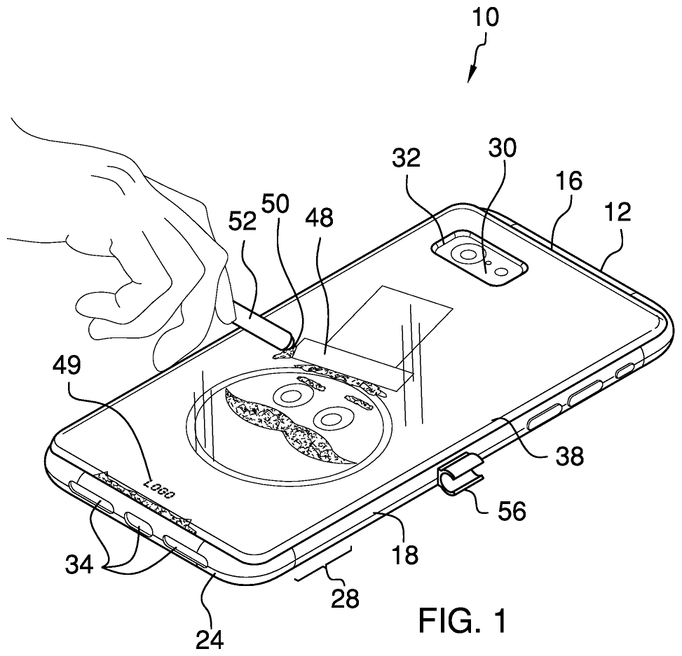

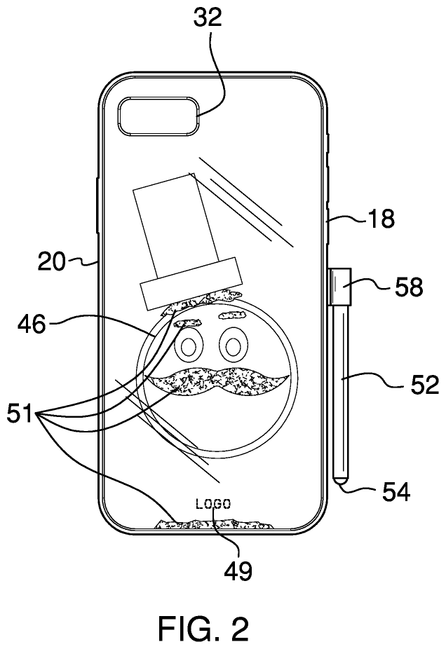

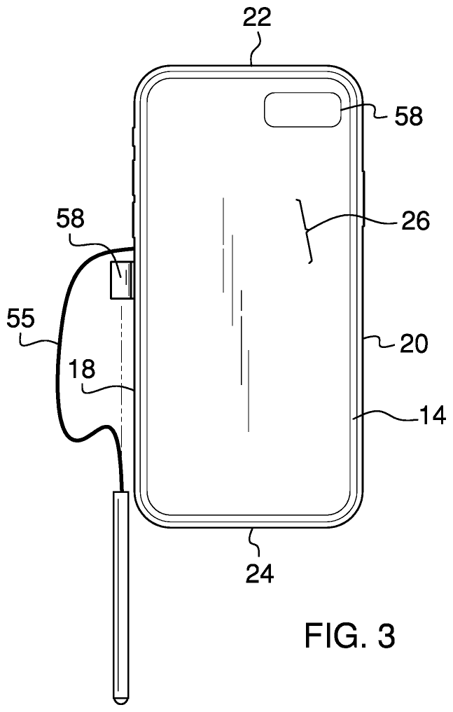

With reference now to the drawings, and in particular to FIGS. 1 through 6 thereof, a new cellphone case device embodying the principles and concepts of an embodiment of the disclosure and generally designated by the reference numeral 10 will be described.

As best illustrated in FIGS. 1 through 6, the cellphone case with integrated game apparatus 10 generally comprises a case body 12 having a case front side 14, a case back side 16, a case left side 18, a case right side 20, a case top side 22, a case bottom side 24, a case inner face 26, and a case outer face 28. The case body 12 is configured to secure a cellphone 30. The case back side 16 may have a camera aperture 32 extending from the case outer face 28 through the case inner face 26. The case left side 18, the case right side 20, the case top side 22, and the case bottom side 24 may have a plurality of feature apertures 34 and a plurality of feature notches 36 extending from the case outer face 28 through the case inner face 26 to accommodate features of the cellphone 30 such as buttons, switches, speakers, and the like.

A game enclosure 38 is coupled to the case body 12. The game enclosure 38 has an enclosure back side 40 coupled to the case outer face 28 on the case back side 16 and a transparent enclosure front side 42 coupled to the enclosure back side 40 and defining an enclosure inside 44. The game enclosure 38 may occupy an entirety of the case back side 16 and may surround the camera aperture 32. The enclosure back side 40 may have a graphic 46. A game 48 is coupled within the game enclosure 38. The game 48 comprises at least one movable game piece 50 within the enclosure inside 44 that may be manipulated by the user. The game 48 may be, but is not limited to, a puzzle, a maze, a dexterity exercise, or the like. A logo 49 may be printed or etched on the enclosure front side 42 proximal the base bottom side 24.

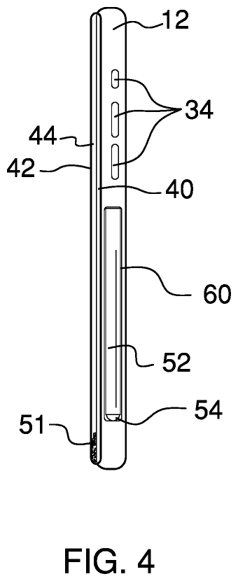

In one embodiment of the invention shown in FIGS. 1, 2, 3, and 4, the movable game piece 50 is a plurality of ferrous shavings 52. The game 48 further comprises a wand 52 having a magnetic tip 54. A tether 55 may be coupled between the wand 52 and the case left side 18 to prevent loss of the wand 52. There may be a wand holder 56 coupled to the case body 12 to selectively secure the wand 52. The wand holder 56 may be a semi-cylindrical clip 58 as shown in FIG. 1, 2, and 3, or may alternatively be a channel 60 extending into the case left side 18 and dimensioned to secure the wand 52 with either a magnet or a press fit as shown in FIG. 4. The magnetic tip 54 of the wand is used to manipulate the plurality of ferrous shavings 52, which may be done so in coordination with the graphic 46.

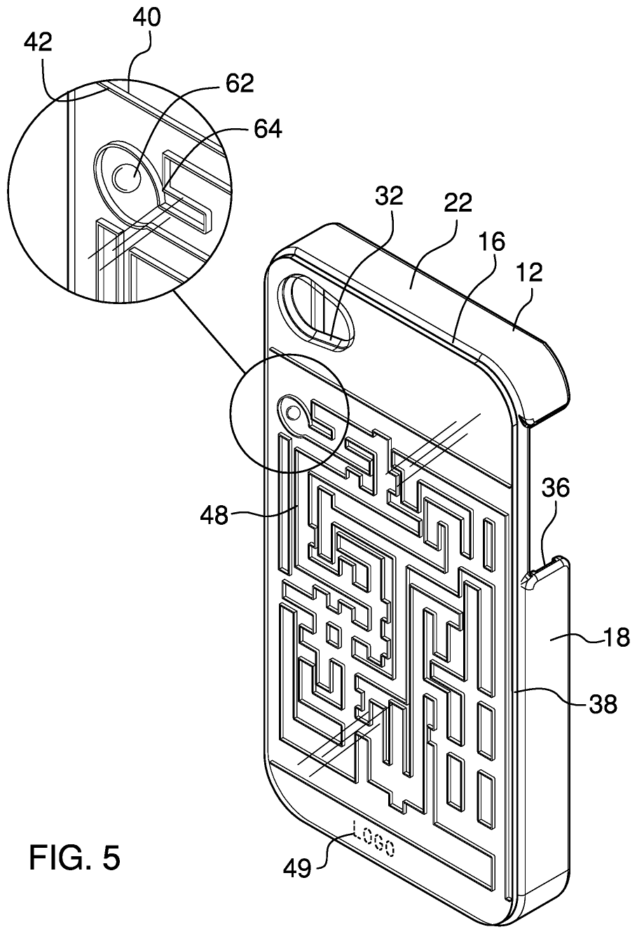

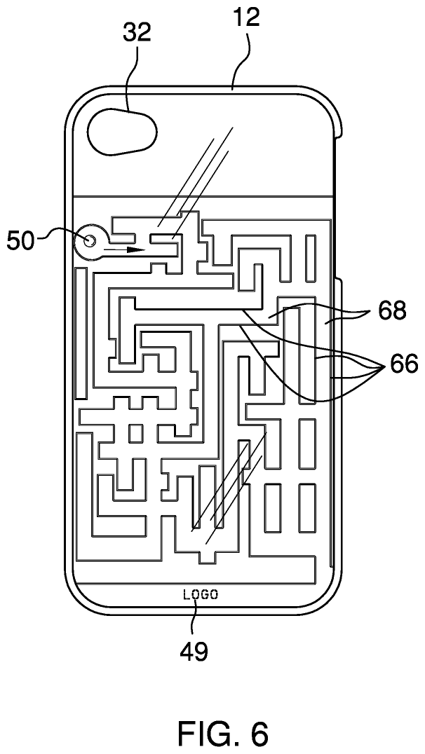

In an alternative embodiment of the invention shown in FIGS. 5 and 6, the movable game piece 50 is a ball 62. The game 48 further comprises a maze wall 64 coupled to the enclosure back side 40 and extending towards the enclosure front side 42. The maze wall 64 has a plurality of parallel sections 66 defining a plurality of maze passages 68. The user is able to navigate the ball 62 through the maze passages 68 by tilting the apparatus 10.

In use, the user places his or her cellphone 30 within the case body 12 for the typical protections afforded by a standard phone case. The user may then manipulate the movable game piece 50 within the game enclosure 38 for entertainment, creative expression, anxiety reduction, or dexterity exercise.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A cellphone case with integrated game apparatus comprising:
a case body having a case front side, a case back side, a case left side, a case right side, a case top side, a case bottom side, a case inner face, and a case outer face, the case body being configured to secure a cellphone;
a game enclosure coupled to the case body, the game enclosure having an enclosure back side coupled to the case outer face on the case back side and a transparent enclosure front side coupled to the enclosure back side and defining an enclosure inside; and
a game coupled within the game enclosure, the game comprising at least one movable game piece within the enclosure inside.

2. The cellphone case with integrated game apparatus of claim 1 further comprising a wand having a magnetic tip and the movable game piece being a plurality of ferrous shavings.

3. The cellphone case with integrated game apparatus of claim 2 further comprising a wand holder coupled to the case body, the wand holder being coupled to the case left side, the wand being selectively engageable within the wand holder.

4. The cellphone case with integrated game apparatus of claim 3 further comprising the wand holder being semi-cylindrical.

5. The cellphone case with integrated game apparatus of claim 2 further comprising a tether coupled between the wand and the case left side.

6. The cellphone case with integrated game apparatus of claim 2 further comprising the enclosure back side having a graphic.

7. A cellphone case with integrated game apparatus comprising:
a case body having a case front side, a case back side, a case left side, a case right side, a case top side, a case bottom side, a case inner face, and a case outer face, the case body being configured to secure a cellphone;
a game enclosure coupled to the case body, the game enclosure having an enclosure back side coupled to the case outer face on the case back side and a transparent enclosure front side coupled to the enclosure back side and defining an enclosure inside, the enclosure back side having a graphic; and
a game coupled within the game enclosure, the game comprising:
at least one movable game piece within the enclosure inside, the movable game piece being a plurality of ferrous shavings;
a wand, the wand having a magnetic tip;
a tether coupled between the wand and the case left side; and
a wand holder coupled to the case body, the wand holder being coupled to the case left side, the wand being selectively engageable within the wand holder.

8. The cellphone case with integrated game apparatus of claim 1 further comprising the game including a maze wall coupled to the enclosure back side and extending towards the enclosure front side, the movable game piece being a ball.

9. The cellphone case with integrated game apparatus of claim 8 further comprising the maze wall having a plurality of parallel sections defining a plurality of maze passages, the user being able to navigate the ball through the maze passages by tilting the apparatus.

10. A cellphone case with integrated game apparatus comprising:
a case body having a case front side, a case back side, a case left side, a case right side, a case top side, a case bottom side, a case inner face, and a case outer face, the case body being configured to secure a cellphone;
a game enclosure coupled to the case body, the game enclosure having an enclosure back side coupled to the case outer face on the case back side and a transparent enclosure front side coupled to the enclosure back side and defining an enclosure inside; and
a game coupled within the game enclosure, the game comprising:
at least one movable game piece within the enclosure inside, the movable game piece being a ball; and
a maze wall coupled to the enclosure back side and extending towards the enclosure front side, the maze wall having a plurality of parallel sections defining a plurality of maze passages, the user being able to navigate the ball through the maze passages by tilting the apparatus.
